(19) United States
(12) Patent Application Publication
(10) Pub. No.: US 2015/0296306 A1
(43) Pub. Date: Oct. 15, 2015

(54) MEMS MOTORS HAVING INSULATED SUBSTRATES

(71) Applicant: Knowles Electronics, LLC., Itasca, IL (US)

(72) Inventors: Ning Shao, Bartlett, IL (US); Eric J. Lautenschlager, Geneva, IL (US)

(21) Appl. No.: 14/669,766

(22) Filed: Mar. 26, 2015

Related U.S. Application Data
(60) Provisional application No. 61/977,925, filed on Apr. 10, 2014.

(51) Int. Cl. H04R 23/00

(52) U.S. Cl. CPC H04R 23/00; H04R 2201/003

(57) ABSTRACT

A microelectromechanical system (MEMS) die includes a substrate, an insulation layer disposed adjacent to the substrate, a diaphragm connected to the insulation layer, and a back plate connected to the insulation layer. The back plate is disposed in spaced relation to the diaphragm. The insulation layer is positioned between the substrate and the diaphragm and back plate to electrically isolate the substrate from the diaphragm and the back plate.

### CROSS REFERENCE TO RELATED APPLICATION

This application which claims the benefit of U.S. Provisional Application No. 61/977,925 entitled “MEMS Motors Having Insulated Substrates” filed Apr. 10, 2014, the contents of which are incorporated herein by reference in its entirety.

### TECHNICAL FIELD

This application relates to acoustic devices and, more specifically, to the configurations of these devices.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)). A MEMS die typical has disposed on it a diaphragm and a back plate. Changes in sound energy move the diaphragm, which changes the capacitance involving the back plate thereby creating an electrical signal. The MEMS die is typically disposed on a base or substrate along with the ASIC and then both are enclosed by a lid or cover.

Microphones are susceptible to interference radio frequency (RF) signals. If no protective action is taken, then a degradation of performance of the microphone may result.

A MEMS motor typically includes the MEMS dies, the back plate, and the diaphragm. In some applications it is sometimes desirable to utilize multiple MEMS motors. However, previous approaches that utilized multiple MEMS motors have been unsatisfactory for some purposes and have had some operational problems.

The above-mentioned problems have created some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1A comprises a perspective view of a single motor MEMS microphone according to various embodiments of the present invention;

FIG. 1B comprises a cross-sectional view of the MEMS microphone of FIG. 1A according to various embodiments of the present invention;

FIG. 1C comprises a cross-sectional view of the MEMS motor of the MEMS microphone illustrated in FIG. 1A and FIG. 1B according to various embodiments of the present invention;

FIG. 2A comprises a perspective view of a dual and ungrounded motor MEMS microphone, in differential configuration, according to various embodiments of the present invention;

FIG. 2B comprises a cross-sectional view of the MEMS motor of the MEMS microphone illustrated in FIG. 2A according to various embodiments of the present invention;

FIG. 3 comprises a perspective view of a dual and grounded motor MEMS microphone, in differential configuration, according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

MEMS motors with insulated substrates are provided. A single motor with a grounded substrate is provided, in one aspect. In other aspect, dual (or multiple) motors are provided on a single chip. With multiple motors, the substrate may be grounded or ungrounded. In one advantage, the grounding reduces the susceptibility of the MEMS motors to radio frequency (RF) signals or noise. In another advantage, differential MEMS motors are provided on a single instead of multiple integrated circuits or chips.

In many of these embodiments, a microelectromechanical system (MEMS) die includes a substrate, an insulation layer disposed adjacent to the substrate, a diaphragm connected to the insulation layer, and a back plate connected to the insulation layer, the back plate disposed in spaced relation to the diaphragm, where the insulation layer is positioned between the substrate and the diaphragm, and between the substrate and the back plate to electrically isolate the substrate from the diaphragm and the back plate.

In some aspects, the substrate is doped silicon. In other aspects, the substrate is coupled to ground.

In some examples, the insulation layer comprises silicon nitride. In other examples, the back plate includes a poly-silicon layer and a nitride layer.

In some aspects, the back plate includes a plurality of apertures disposed therethrough.

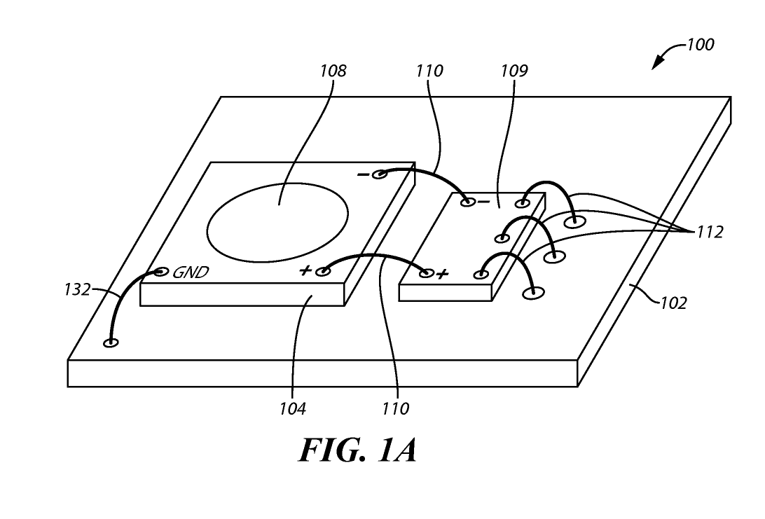

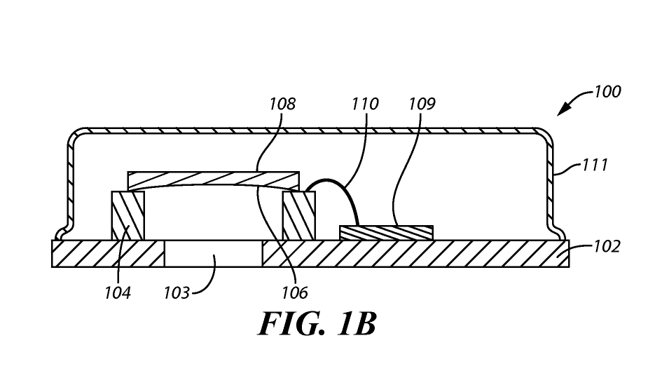

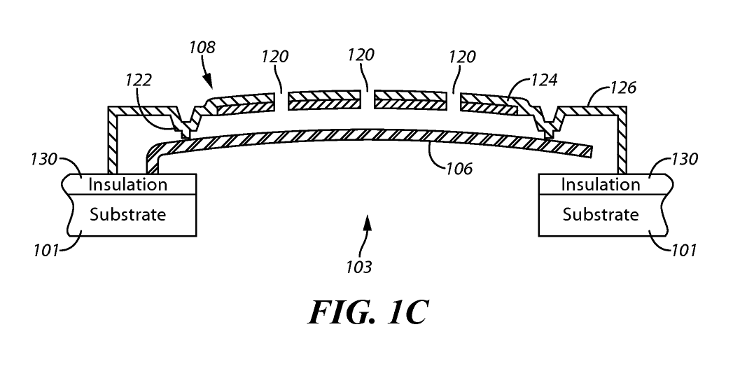

Referring now to FIGS. 1A, FIG. 1B, and 1C one example of a microelectromechanical system (MEMS) microphone 100 includes a substrate 102. The substrate 102 may be any type of base such as a printed circuit board. Other examples of substrates are possible.

Disposed on the substrate 102 is a MEMS die 104. The MEMS die 104 includes a substrate 101, an insulation layer 130, a diaphragm 106, and a back plate 108 (together forming a MEMS motor). The substrate 101 may be any type of base such as doped silicon. Other examples of substrates are possible. In one example, the insulation layer 130 is constructed of silicon nitride. Other examples of materials may also be used to construct the insulation layer 130. Sound enters the microphone 100 via a port 103, which extends through the substrate 102. Alternatively, the port 103 may extend through a lid or cover 111 that covers the substrate 102/insulation layer 130 and the elements that are disposed on the substrate 102/insulation layer 130.

The back plate 108 includes a plurality of holes or openings 120. The purpose of the holes 120 is sound transmission/pressure relief/pressure equalization. A plurality of posts 122 provide support for the back plate 108. The back plate 108 includes a poly-silicon layer 124 and a silicon nitride layer 126.

The purpose of the poly-silicon layer 124 is to pickup or send the signal generated from diaphragm. The purpose of the silicon nitride layer 126 is to mechanically support poly-silicon layer 124. The back plate 108 is electrically charged. As the diaphragm 106 moves, the electrical potential between the back plate 108 and the diaphragm 106 changes thereby creating an electrical signal. If sound moves the diaphragm 106, then the electrical signal is representative of the sound. The insulation layer 130 electrically isolates the substrate 101 from both the diaphragm 106 and the back plate electrode (i.e., constructed from the poly-silicon layer 124). The substrate 102 can be coupled by a connection 132 to ground (electrical ground).

An application specific integrated circuit (ASIC) 109 is also disposed on the substrate 102. The ASIC 109 may perform various signal processing functions, to mention one example of its use. The MEMS die 104 is coupled to the ASIC 109 by wires 110. The ASIC 109 is coupled to the substrate by wires 112.

In one example of the operation of the microphone 100, sound enters the port 103 and moves the diaphragm 106. Movement of the diaphragm 106 changes the capacitance involving the back plate 108 thereby creating an electrical signal. The electrical signal may be transmitted to the ASIC 109 via wires 110. After processing of the signal by the ASIC 109, the processed signal is sent over wires 112, which couple to pads on the bottom of the substrate 102. A customer may couple other electronic devices to these pads. For example, the microphone may be disposed in a cellular phone or a personal computer and appropriate circuitry from these devices may be coupled to the pads.

The insulation layer 130 electrically isolates the substrate 101 from both the diaphragm 106 and the back plate electrode. In this single motor example, the insulation allows the substrate to be grounded. This leads to reduced susceptibility to radio frequency (RF) signals.

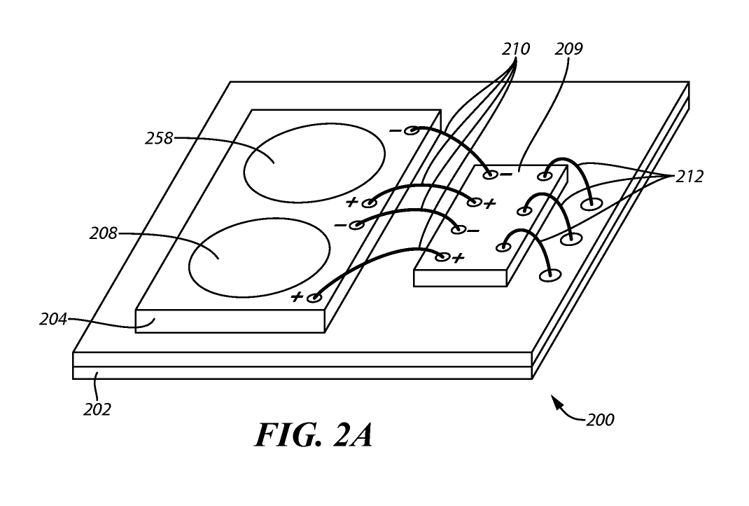

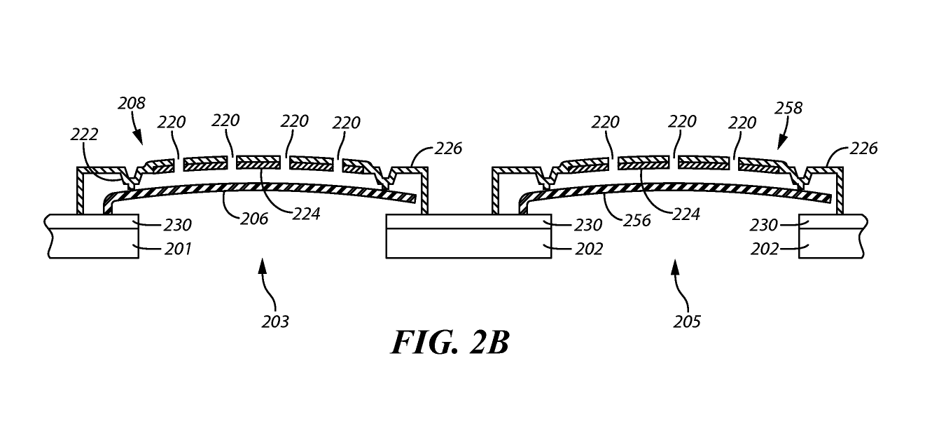

Referring now to FIG. 2A and FIG. 2B, one example of a microelectromechanical system (MEMS) microphone 200 with dual MEMS motors includes a substrate 202. The substrate 202 may be any type of base such as a printed circuit board. Other examples of substrates are possible.

In the multiple motor examples described herein, two motors are used. However, it will be appreciated that the approaches described herein are not limited to two motors and, in fact, any number of MEMS motors can be used.

Disposed on the substrate 202 is a MEMS die 204. The MEMS die 204 includes a first diaphragm 206 and a first back plate 208 (together forming a first MEMS motor). Sound enters the microphone 200 via a first port 203, which in one example extends through the substrate 202. Alternatively, the first port 203 may extend through a lid or cover (not shown) that covers the substrate 202 and the elements that are disposed on the substrate 202.

The MEMS die 204 includes a second diaphragm 256 and a second back plate 258 (together forming a second MEMS motor). Sound enters the microphone 200 via a second port 205, which in one example extends through the substrate 202. Alternatively, the second port 205 may extend through a lid or cover (not shown) that covers the substrate 202 and the elements that are disposed on the substrate 202.

The first back plate 208 and second back plate 258 include a plurality of holes or openings 220. The purpose of the holes 220 is sound transmission/pressure relief/pressure equalization. A plurality of posts 222 provide support for the back plates 208 and 258. The back plates 208 and 258 include a poly-silicon layer 224 and a silicon nitride layer 226.

The purpose of the poly-silicon layer 224 is to pickup or send the signal generated from diaphragm. The purpose of the silicon nitride layer 226 is to mechanically support poly-silicon layer 224. The back plates 208 and 258 are electrically charged. As the first diaphragm 206 and the second diaphragm 256 move, the electrical potentials between the back plates 208 and 258, and the diaphragms 206 and 256 change thereby creating an electrical signal. If sound moves the diaphragms 206 and 256, then the electrical signal is representative of the sound. The insulation layer 230 electrically isolates the substrate 201 from the diaphragms 206 and 256, and the back plate electrodes (i.e., constructed from the poly-silicon layer 224) of back plates 208 and 258. In this example, the substrate 201 is not coupled to ground (electrical ground).

An application specific integrated circuit (ASIC) 209 is also disposed on the substrate 202. The ASIC 209 may perform various signal processing functions, to mention one example of its use. The MEMS die 204 is coupled to the ASIC 209 by wires 210. The ASIC 209 is coupled to the substrate by wires 212.

In some approaches, all motors' diaphragms share the same electrical potential. The isolation layer allows diaphragms to be biased separately. One example is that one motor has positive charge on diaphragm and negative charge on back plate, with the other motor having negative charge on diaphragm and positive charge on back plate. These two motors can be fabricated on a single silicon substrate using the as-deposited insulation layer.

The two motors work at the same time—effectively double the sensitivity, while only adding 50% more noise. This approach will effectively increase SNR by 3 dB. Of course, this approach is not limited to only two motors, the number of motors can be any number.

In one example of the operation of the microphone 200, sound enters the ports 203 and/or 205 and moves the diaphragms 206 or 256. Movement of the diaphragms 206 or 256 changes the capacitance involving the back plates 208 or 258 thereby creating an electrical signal. The electrical signal may be transmitted to the ASIC 209 via wires 210. After processing of the signal by the ASIC 209, the processed signal is sent over wires 212, which couple to pads on the bottom of the substrate 202. A customer may couple other electronic devices to these pads. For example, the microphone may be disposed in a cellular phone or a personal computer and appropriate circuitry from these devices may be coupled to the pads.

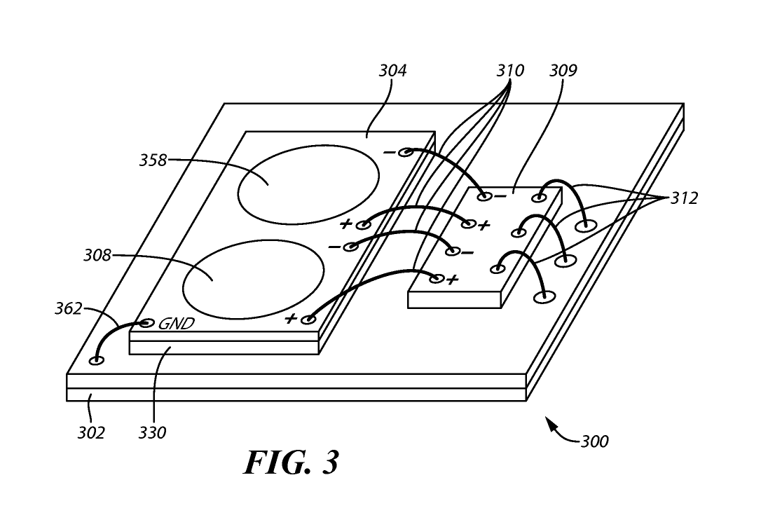

Referring now to FIG. 3, another example of a dual motor MEMS microphone is described. This example is similar to the example of FIG. 2A and FIG. 2B. Identical parts are numbered in the same way in FIG. 3 as in FIGS. 2A and 2B. For example, substrate 302 in FIG. 3 corresponds to substrate 202 in FIG. 2A and FIG. 2B. The difference between the example of FIG. 3 and the example of FIGS. 2A and 2B is that the example of FIG. 3 has its substrate coupled to ground.

A MEMS microphone 300 includes a substrate 302. The substrate 302 may be any type of base such as a printed circuit board. Other examples of substrates are possible.

An application specific integrated circuit (ASIC) 309 is also disposed on the substrate 302. The ASIC 309 may perform various signal processing functions, to mention one example of its use. The MEMS die 304 is coupled to the ASIC 308 by wires 310. The ASIC 308 is coupled to the substrate by wires 312. The substrate 302 can be coupled by a connection 362 to ground (electrical ground). An insulation layer 330 electrically isolates the substrate 302 from both the diaphragm 306 and the back plate electrode. This leads to reduced susceptibility to radio frequency (RF) signals for both motors in this example.

The MEMS die 304 includes a first diaphragm (not shown) and a first back plate 308 (together forming a first MEMS motor). Sound enters the microphone 300 via a first port, which in one example extends through the substrate 302 and the insulation layer. Alternatively, the first port may extend through a lid or cover (not shown) that covers the substrate 302 and the elements that are disposed on the substrate 302.

The MEMS die 304 includes a second diaphragm (not shown) and a second back plate 358 (together forming a second MEMS motor). Sound enters the microphone 300 via a second port, which in one example extends through the substrate 302. Alternatively, the second port 305 may extend through a lid or cover (not shown) that covers the substrate 302 and the elements that are disposed on the substrate 302.

The insulation layer 330 electrically isolates the substrate 302 from both the first diaphragm and the second diaphragm, and the first back plate electrode and the second back plate electrode. The insulation layer 330 allows two differentially biased MEMS motors to be fabricated on a single chip. Because of the grounding of the substrate 302, reduced RF susceptibility is also provided in addition to the differential MEMS motors being provided or disposed on a single chip or integrated circuit.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microelectromechanical system (MEMS) die comprising:
a substrate;
an insulation layer disposed adjacent to the substrate;
a diaphragm connected to the insulation layer; and
a back plate connected to the insulation layer, the back plate disposed in spaced relation to the diaphragm;
wherein the insulation layer is positioned between the substrate and the diaphragm, and between the substrate and the back plate to electrically isolate the substrate from the diaphragm and the back plate.

2. The MEMS die of claim 1, wherein the substrate is doped silicon.

3. The MEMS die of claim 1, wherein the substrate is coupled to ground.

4. The MEMS die of claim 1, wherein the insulation layer comprises silicon nitride.

5. The MEMS die of claim 1, wherein the back plate includes a poly-silicon layer and a nitride layer.

6. The MEMS die of claim 1, wherein the back plate includes a plurality of apertures disposed therethrough.
